(19) United States
(12) Patent Application Publication
(10) Pub. No.: US 2010/0329805 A1
(43) Pub. Date: Dec. 30, 2010

(54) DIAMOND TOOL

(75) Inventors: Sung Ho Cho, Incheon (KR); Jong Seog Park, Gyeonggi-do (KR); Byoung Chul Joo, Incheon (KR)

Correspondence Address: SEED INTELLECTUAL PROPERTY LAW GROUP PLLC, 701 FIFTH AVE, SUITE 5400, SEATTLE, WA, 98104, US

(73) Assignee: Shinhan Diamond Ind. Co., Ltd., Incheon (KR)

(21) Appl. No.: 12/823,056

(22) Filed: Jun. 24, 2010

(30) Foreign Application Priority Data
Jun. 25, 2009 (KR) 10-2009-0056868

(51) Int. Cl. B23B 27/20

(52) U.S. Cl. 408/144; 407/119

(57) ABSTRACT

Disclosed is a diamond tool. The diamond tool is coupled to a processing apparatus and may form a hole in a workpiece. The diamond tool includes a shank coupled to a connection portion formed at one end thereof and further coupled to the processing apparatus. There is a cylindrical opening formed at the other end of the shank; and segments formed at intervals along the periphery of the shank, the segments come into contact with the workpiece to form a hole in the workpiece. Each of the segments has at least one linear groove formed on the inner surface thereof or at least one oblique groove formed on the outer surface thereof. The segments are improved in shape to achieve improved cutting and cooling performance, increased stiffness and durability, and reduced load upon processing.

### CROSS-REFERENCE TO RELATED APPLICATION

This application claims priority from and the benefit of Korean Patent Application No. 10-2009-0056868, filed Jun. 25, 2009, which is hereby incorporated by reference for all purposes as if fully set forth herein.

### BACKGROUND

1. Field of the Disclosed Subject Matter

The presently disclosed subject matter relates to a diamond tool, and more specifically to a diamond tool in which segments are improved in shape to form a hole in a workpiece.

2. Description of the Related Art

Generally, diamond tools are used to cut or grind the surfaces of workpieces. Diamond tools are also used to process the inner diameter surfaces, inner surfaces, outer rings and inner rings of workpieces. Another use of diamond tools is to form holes in workpieces.

FIG. 1 is a perspective view of a diamond tool 10 suitable for the formation of a hole in a workpiece according to related art.

As illustrated in FIG. 1, the diamond tool 10 has a cylindrical shank 12 and a plurality of segments 14 spaced at regular intervals from each other over the entire periphery of one end of the shank 12. The segments 14 are fixedly held to the shank 12.

The segments 14 contain diamond grits. The term “diamond grits” as used herein is intended to include natural diamond, artificial diamond, cubic boron nitride (c-BN), alumina (Al₂O₃), silicon carbide, silicon carbide (SiC) and titanium carbide (TiC) abrasive particles.

Further, each of the segments 14 has a linear groove 16 formed at one side thereof. The segments 14 are fixed to the shank 12 in such a manner that the grooves 16 are alternately exposed to the inside and outside of the diamond tool 10. The segments 14 of the diamond tool 10 come into direct contact with the surface of a workpiece to form a hole in the workpiece.

The diamond tool 10 is constructed such that cut chips escape through the grooves 16 of the segments 14 during processing, thus achieving improved cutting performance. Nevertheless, there is room for improvement of cutting performance. The inner and outer grooves of the segments 14 formed in the same direction make it difficult to maintain the stiffness of the diamond tool 10. Further, the direction of the cut chips escaping from the diamond tool 10 is orthogonal to the rotational direction of the diamond tool 10, which impedes the escaping of the cut chips and limits the cooling of the diamond tool 10. Further, since the grooves 16 come into intermittent contact with the workpiece to form a hole, a large load takes place during processing, a contact impact is continuously transmitted to the diamond tool 10, and the contact area increases, which become causes of deteriorated durability and increased processing load.

### SUMMARY OF THE DISCLOSED SUBJECT MATTER

The disclosed subject matter has been made in view of the problems of the related art as discussed above to provide a diamond tool in which segments are improved in shape to achieve improved cutting and cooling performance, increased stiffness and durability, and reduced load upon processing.

In order to accomplish the above object, there is provided a diamond tool coupled to a processing apparatus to form a hole in a workpiece, the diamond tool comprising: a shank having a connection portion formed at one end thereof to be coupled to the processing apparatus and a cylindrical opening formed at the other end thereof; and segments formed at predetermined intervals along the periphery of the shank and coming into contact with the workpiece to form a hole in the workpiece, wherein each of the segments has at least one linear groove formed on the inner surface thereof or at least one oblique groove formed on the outer surface thereof.

In an embodiment, the oblique groove may be inclined toward the rotational direction of the diamond tool.

### BRIEF DESCRIPTION OF THE DRAWINGS

These and/or other aspects and advantages of the disclosed subject matter will become apparent and more readily appreciated from the following description of the embodiments, taken in conjunction with the accompanying drawings of which:

FIG. 1 is a perspective view of a diamond tool according to the related art;

FIG. 2 is a perspective view of a diamond tool according to the disclosed subject matter; and

FIG. 3 is a cross-sectional view illustrating a state in which a hole is formed in a workpiece by using the diamond tool of FIG. 2.

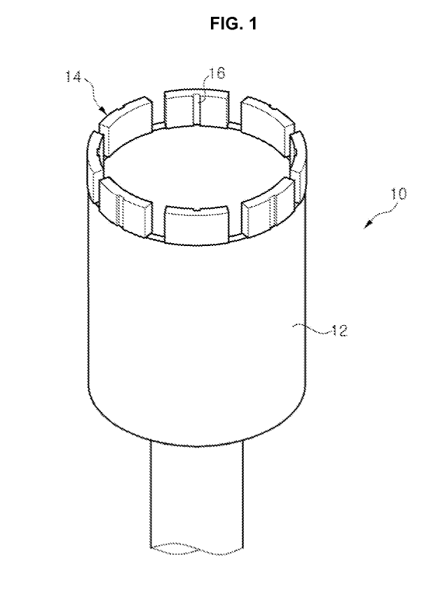

### DETAILED DESCRIPTION OF THE DISCLOSED SUBJECT MATTER

Exemplary embodiments of the disclosed subject matter will now be described with reference to the accompanying drawings.

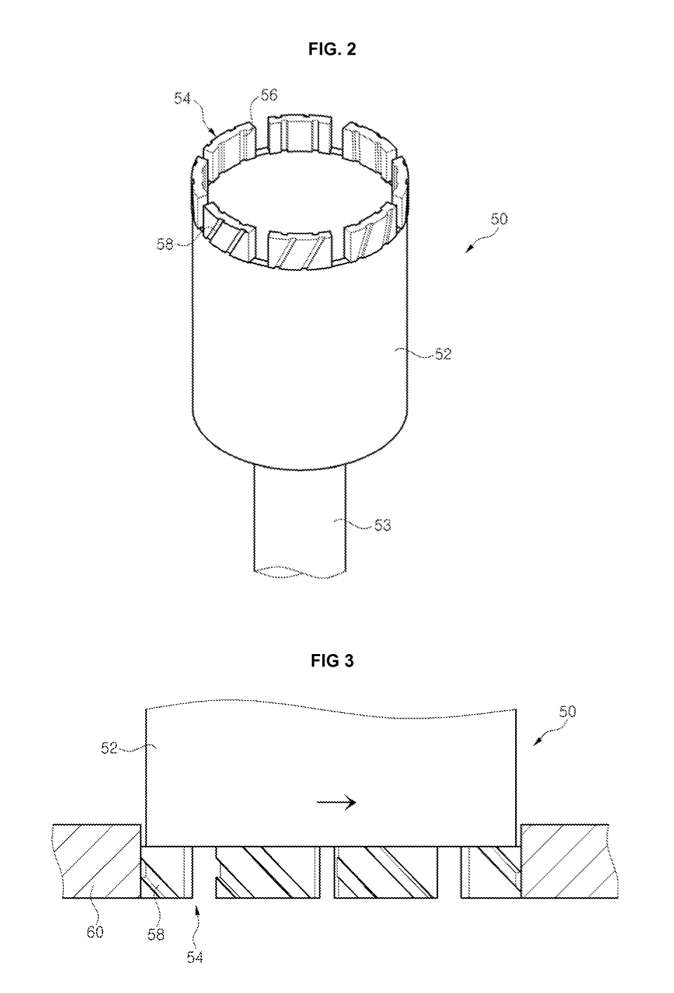

FIG. 2 is a perspective view of a diamond tool 50 according to an embodiment of the disclosed subject matter.

As illustrated in FIG. 2, the diamond tool 50 is coupled to a processing apparatus (not shown) to process a workpiece (not shown). The diamond tool 50 may vary in shape depending on the application. For example, the diamond tool 50 can be used for surface polishing or hole processing.

As one example, the diamond tool 50 may be used as a core drill or a hole cutter to form a hole in a workpiece. The diamond tool 50 comprises a shank 52 coupled to the processing apparatus (not shown) through a connection portion 53, which is formed at one end of the shank 52. The shank 52 may vary in size depending on the shape of a workpiece to be processed. The shank 52 preferably has a cylindrical shape.

The other end of the shank 52 is open. Segments 54 are provided at the periphery of the other end of the shank 52. When the processing apparatus rotates at a high speed, the segments 54 come into direct contact with a workpiece to grind or cut the workpiece. By this processing, a hole can be formed in the workpiece.

The segments 54 can be formed by mixing diamond grits with a binder and sintering the mixture. The segments 54 may be joined to the shank 52 by melt-bonding or laser welding. Alternatively, an adhesive may be used to join the segments 54 to the shank 52. For example, the segments 54 may be integrally formed with the shank 52 by electrodeposition or melt-bonding.

Auxiliary segments (not shown) may be provided on the inner or outer circumferential surface of the shank 52.

The auxiliary segments formed on the inner circumferential surface of the shank 52 grind the outer circumferential surface of a workpiece cut by the segments 54 and inserted into the shank 52. This grinding decreases the outer diameter of the workpiece to facilitate escaping of the workpiece.

The auxiliary segments formed on the outer circumferential surface of the shank 52 process the outer circumferential surface of a hole of a workpiece formed after processing. This processing allows the diamond tool 50 to enter the hole and can ensure more accurate processing dimensions.

The auxiliary segments may be formed continuously or intermittently at predetermined intervals on the inner or outer circumferential surface of the shank 52. Alternatively, the auxiliary segments may be formed continuously in a spiral arrangement.

Each of the segments 54 has one or two grooves 56 formed linearly on the inner surface thereof and one or two grooves 58 formed obliquely on the outer surface thereof.

The oblique grooves 58 may be inclined toward the rotational direction of the diamond tool 50. The formation of the grooves 56 and 58 in different directions can enhance the durability and stiffness of the segments 54. Upon processing of a workpiece to form a hole, the oblique grooves 58 of the segments 54 come into continuous contact with the workpiece. The contact area between the oblique grooves 58 and the workpiece gradually increases to protect the segments 54 from contact impact. Further, the oblique grooves 58 are inclined relative to the rotational direction of the diamond tool 50. With this configuration, cut chips from a workpiece can easily escape outside along the inclined surfaces of the oblique grooves 58 during processing. Furthermore, the cutting load of the processing apparatus upon processing of a workpiece can be reduced due to the small contact area of the segments 54 as a whole, achieving increased service life and cutting performance of the diamond tool.

FIG. 3 is a cross-sectional view illustrating a state in which a hole is formed in a workpiece by using the diamond tool 50. The operation of the diamond tool 50 will be described below with reference to FIG. 3.

First, the connection portion 53, as shown in FIG. 2, formed at one end of the diamond tool 50 is coupled to a processing apparatus (not shown). The diamond tool 50 rotates at a high speed on a workpiece 60 to form a hole in the workpiece 60.

When the segments 54 of the diamond tool 50 come into contact with the workpiece 60, chips cut out from the workpiece by the segments 54 escape outside from the diamond tool 50 and workpiece 60 through the oblique grooves 58. Further, the formation of the oblique grooves 58 in the segments 54 decreases the contact area between the segments 54 and the workpiece, allowing for the rotation of the diamond tool 50 at a high speed without generating a substantial cutting load.

As is apparent from the above description, the linear and oblique grooves 56 and 58, respectively (as seen in FIG. 2), are formed on the inner and outer surfaces of the segments 54 of the diamond tool 50, respectively. Cut chips from a workpiece during processing can rapidly escape from the diamond tool 50 through the grooves 56 and 58, resulting in an improvement in the cooling performance of the diamond tool 50. In addition, the oblique grooves 58 formed on the outer surfaces of the segments 54 can maintain the stiffness of the diamond tool 50 to protect the segments 54 from damage such as breakage, bending or fracture. Further, the oblique grooves 58 of the segments 54 are inclined toward the rotational direction of the diamond tool 50 to facilitate the escaping of cut chips and the release of heat during processing. Further, the contact area between the segments 54 of the diamond tool 50 and the workpiece 60 can be maintained small, thus resulting in reduction of a cutting load during processing of the workpiece 60. Furthermore, when the segments 54 come into contact with a workpiece 60, the oblique grooves 58 of the segments 54 provide passages through which cut chips from the workpiece 60 can escape. Moreover, the oblique grooves 58 allow continuous contact between the segments 54 and the workpiece 60, thus reducing the occurrence of contact impact during processing. Therefore, the diamond tool 50 according to one embodiment of the disclosed subject matter has improved durability and contributes to power saving, rapid processing and noise reduction.

Although the disclosed subject matter has been described herein with reference to the foregoing embodiments, these embodiments do not serve to limit the scope of the disclosed subject matter. Those skilled in the art will readily recognize and appreciate that many modifications and variations can be made and such modifications and variations are encompassed within the spirit and scope of the disclosed subject matter as defined in the appended claims.

The various embodiments described above can be combined to provide further embodiments. Any foreign patent and/or corresponding foreign patent application referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

What is claimed is:

1. A diamond tool, comprising:
a shank coupled to a processing apparatus at a first end of the shank, the shank being operable to rotate about an axis of rotation;
a cylindrical opening formed at a second end of the shank; and
one or more segments coupled to the periphery of the cylindrical opening of the shank, the one or more segments having at least one linear groove oriented along the axis of rotation of the shank and being located on an inner surface of the one or more segments and at least one oblique groove being located on an outer surface of the one or more segments.

2. The diamond tool of claim 1, the at least one oblique groove being inclined along the outer surface of the one or more segments toward the rotational direction of the shank.

3. The diamond tool of claim 1, the one or more segments are formed of at least diamond grits.

4. The diamond tool of claim 1, the one or more segments are coupled to the periphery of the cylindrical opening of the shank by at least one of melt-bonding, laser welding or adhesion.

5. The diamond tool of claim 1, further comprising auxiliary segments being formed on the sides of the shank.

6. The diamond tool of claim 5, the auxiliary segments being formed on at least one of the inner side of the shank or the outer side of the shank.

7. The diamond tool of claim 5, the auxiliary segments being formed either continuously or intermittently on the sides of the shank.

8. The diamond tool of claim 7, the auxiliary segments being formed in a spiral arrangement along the sides of the shank.

9. A diamond tool, comprising:
a shank; and
at least one segment coupled to the shank, the at least one segment having at least one oblique groove located on a surface of the at least one segment.

10. The diamond tool of claim 9, the at least one segment includes one or more segments coupled to an opening end of the shank.

11. The diamond tool of claim 10, the one or more segments coupled to the opening end of the shank having the at least one oblique groove located on an inner surface of the one or more segments and at least one linear groove located on an outer surface of the one or more segments.

12. The diamond tool of claim 9, the at least one oblique groove being inclined in the same direction as a rotational direction of the shank.

13. The diamond tool of claim 9, the at least one segment includes one or more segments coupled to at least one side of the shank.

14. The diamond tool of claim 13, the one or more segments coupled to the at least one side of the shank being auxiliary segments formed either continuously or intermittently on the at least one side of the shank.

15. The diamond tool of claim 13, the one or more segments coupled to the at least one side of the shank being auxiliary segments formed in a spiral arrangement on the at least one side of the shank.
